(19) United States
(12) Patent Application Publication
(10) Pub. No.: US 2024/0378209 A1
(43) Pub. Date: Nov. 14, 2024

(54) QUERY CLUSTERING IN SEARCH RESULT DETERMINATION AND RANKING

(71) Applicant: Home Depot Product Authority, LLC, Atlanta, GA (US)

(72) Inventors: Duleep Rathgamage Don, Marietta, GA (US); Ying Xie, Marietta, GA (US); Le Yu, Marietta, GA (US); Simon Hughes, Atlanta, GA (US); Yun Zhu, Alpharetta, GA (US)

(21) Appl. No.: 18/658,360

(22) Filed: May 8, 2024

Related U.S. Application Data
(63) Continuation of application No. 63/465,128, filed on May 9, 2023.

(51) Int. Cl. G06F 16/2457; G06F 16/28

(52) U.S. Cl. CPC G06F 16/24578; G06F 16/285

(57) ABSTRACT

A method for providing a ranked set of search results includes receiving, from a device, a query, determining, via a first machine learning model, an initial set of documents responsive to the received query, accessing a second machine learning model, the second machine learning model selected from a set of machine learning models based on a characteristic of the query, ranking, via the second machine learning model, the initial set of documents based on responsiveness to the query to generate the ranked set of search results, and outputting the ranked set of search results on the device.

### CROSS-REFERENCE TO RELATED APPLICATION

This application claims the benefit of priority to U.S. Pat. App. No. 63/465,128, filed May 9, 2023, the contents of which are incorporated herein in their entirety and for all purposes.

### FIELD OF THE DISCLOSURE

The present disclosure generally relates to determining and ranking search results, including by clustering queries and applying cluster-specific search models.

### BRIEF DESCRIPTION OF THE DRAWINGS

FIG. 1 is a block diagram illustrating an example system for determining and ranking search results.

FIG. 2 is a flow chart illustrating an example method of training a plurality of models for use in search result determination and ranking.

FIG. 3 is a flow chart illustrating an example method of determining, ranking, and outputting search results in response to a search query.

FIG. 4 is a diagrammatic view of an example user computing environment.

### DETAILED DESCRIPTION

A robust retrieval and ranking system should be able to understand the underlying semantics of queries and provide personalized results that meet the specific needs of individual users. Traditional retrieval models, such as the Vector Space Model and Latent Semantic Analysis, have been effective in capturing keyword-based relevance between queries and items. However, they often struggle with understanding the nuances of natural language and user intent. Recent advancements in natural language processing and deep learning have led to the development of powerful pre-trained language models, such as BERT, GPT, and ROBERTa. These models have demonstrated impressive performance in various tasks, including e-commerce retrieval and ranking, by capturing the semantic relationships between queries and items. Despite the successes of pre-trained language models, there is still room for improvement, particularly in understanding the diverse nature of user queries and providing tailored retrieval results. The present disclosure improves on known search result ranking approaches through the use of query clustering into the retrieval and ranking process, leveraging the inherent structure of the query space to better adapt the model to different query types. Query clustering can help uncover underlying patterns in user search behavior and create more fine-grained representations of user intent, ultimately leading to improved retrieval performance.

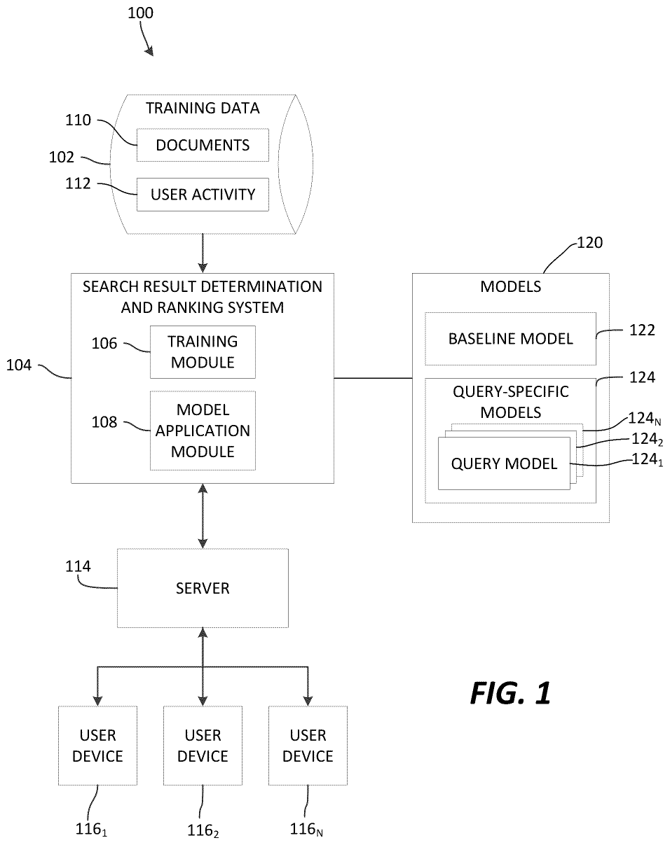

Referring now to the drawings, wherein like numerals refer to the same or similar features in the various views, FIG. 1 is a diagrammatic view of an example system 100 for determining and ranking search results. The system 100 may include a training data source 102 and a search result determination and ranking system 104 that may include one or more functional modules 106, 108 embodied in hardware and/or software. In an embodiment, the functional modules 106, 108 of the search result determination and ranking system 104 may be embodied in a processor and a memory (i.e., a non-transitory, computer-readable medium) storing instructions that, when executed by the processor, cause the processor to perform the functionality of one or more of the functional modules and/or other functionality of this disclosure.

The training data source 102 may include a set of documents 110 and records of user activity 112. In some embodiments, the documents 110 may be documents specific to or otherwise accessible through a particular electronic user interface, such as a website or mobile application. The user activity 112 may be user activity on the electronic user interface, such as user navigations to the documents, user selections of the subjects of the documents, etc. For example, in some embodiments, the documents 110 may be respective of products and services offered through an e-commerce website (e.g., where each documents is respective of a given product or service), and the user activity 112 may include user search queries in an interface through which the documents 110 are accessible, user interactions with the documents themselves (e.g., user navigations to, clicks on, or examinations of the documents), and/or user interactions with the products and services that are the subjects of those documents (e.g., purchases, additions to cart, etc.). In some embodiments, the training data 102 may include associations between particular user search queries, the results that were provided in response to those queries, and the documents that were (and were not) interacted with by users from among those results. Considered in conjunction, the documents 110 and user activity 112 may include domain-specific machine learning model training data that may be used to train query-specific models, as described herein, which may be particularly beneficial for queries submitted to the same domain to which the documents 110 and user activity 112 relate.

The functional modules 106, 108 of the search result determination and ranking system 104 may include a training module 106 that is configured to train a plurality of machine learning models 120 using the training data 102. The plurality of machine learning models 120 may include a baseline model 122 and a set of query-specific models 124 with a plurality of query specific models 1241, 1242, . . . 124N. The baseline model 122 may be configured to, in response to a query, return a set of generally-relevant results. The query-specific models 124 may each be associated with a respective type (e.g., a group or cluster) of queries, and may be configured to, in response to a respective query, return a set of results that are more directly relevant the query type. For example, in some embodiments, the training module 106 may train the baseline model 122 using all of the training data and may separately refine the query-specific models 124 based on respective subsets of the training data. Thus, in some embodiments, one or more of the query-specific models 124 may use the baseline model 122 as an initial (or pre-trained) stage, and may be transformed into a “query-specific” model through further training using data respective of the particular type of query. In some embodiments, one or more of the query-specific models 124 may utilize a pre-trained (or untrained) model that is different from the baseline model 122.

In order to train each query-specific model 124, the training data may be sub-divided to form a set of query clusters, with each of the query clusters used to train a different query-specific model 124. Once trained, each query-specific model 124 is formally associated with the corresponding query cluster within the search result determination and ranking system 104. These clusters may be defined groups of queries that share one or more characteristics indicative of an intent of a respective query. To this end, the one or more characteristics may include a keyword in the query, a category of document identified in the query, a length of the query, etc. Similarity between respective queries may be determined by generating, via a trained embeddings generator model, an embeddings vector that is representative of the query and plots the query within vector-space. A distance between two vectors may then indicate a similarity between the two queries that correspond to the respective vectors.

In some embodiments, the training module 106 may take a bottom-up (or agglomerative) approach to determining clusters by first selecting a single embeddings vector and building a cluster around that embeddings vector by grouping those embeddings vectors within a threshold distance of the first embeddings vector. Once this process is repeated for each query embeddings vector, the training module 106 may form larger clusters by grouping the individual clusters. In other embodiments, training module 106 may take a top-down approach by starting with a cluster that includes all query embeddings vectors. A central embeddings vector may be determined (e.g., as the embeddings vector with the shortest average distance to all other embeddings vectors, relative to the other embeddings vectors) and removing those vectors that are above a threshold distance away from the central vector. A new cluster may be formed from those removed vectors, and the process is repeated until each cluster contains only those vectors within a threshold distance of the respective central vector. In some embodiments, each cluster may be defined in relation to a threshold number (n) of vectors in each cluster, such that each cluster includes the n closest vectors (rather than those vectors within a threshold distance.

The functional modules 106, 108 may also include a model application module 108 that may use the trained baseline model 122 and the query-specific models 124 to determine and rank results to a user search query. For example, model application module 108 may utilize the baseline model 122 to return an initial set of results, and may utilize a respective query-specific model 124 to rank, sort, or otherwise refine the initial set of results. In order to identify the appropriate query-specific model 124, the model application module 108 may generate an embeddings vector for the query at-issue and determine to which cluster (of the clusters established by the training module 106) the query belongs. The model application module 108 may then retrieve and utilize the query-specific model 124 associated with the cluster.

The system 100 may further include a server 114 in electronic communication with the search result determination and ranking system 104 and with a plurality of user computing devices 116₁, 116₂, . . . 116_{N}. The server 114 may provide a website, data for a mobile application, or other interface through which the users of the user computing devices 116 may navigate and otherwise interact with the documents 110. In some embodiments, the server 114 may receive a user search query through the interface and provide responsive results through the interface (e.g., results produced by the model application module 108).

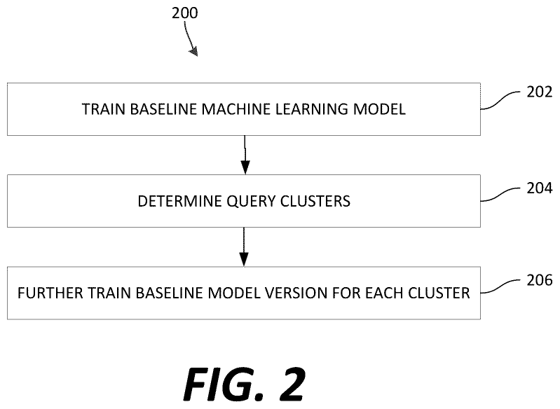

FIG. 2 is a flow chart illustrating an example method of training a plurality of models (e.g., models 120) for use in search result determination and ranking. The method 200, or one or more portions of the method 200, may be performed by the system 100, and more particularly by the search result determination and ranking system 104, in some embodiments.

The method 200 may include, at block 202, training a baseline machine learning model (e.g., baseline model 122). Training the baseline model may include receiving a pre-trained model (e.g., that has been trained a corpus of general documents) and further training the pre-trained model on domain-specific training data (e.g., in the training data 102) to result in a baseline model optimized to determine and rank search results directed to the entirety of the training data or similar domain data. In some embodiments, the baseline model may be trained using multiple different loss functions, such as a cross-entropy loss function or a mean reciprocal rank (MRR) loss function, that may each refine different aspects of the baseline model 122. For example, the cross-entropy loss function may be utilized to improve the ability of the baseline model 122 to retrieve relevant documents, and the MRR loss function may be utilized to improve the ability of the baseline model 122 to initially rank (or order) the retrieved documents. In some embodiments, multiple models may be collectively minimized through parallel processes. In some embodiments, each of the multiple models may be individually minimized through sequential processes.

The method 200 may further include, at block 204, determining a plurality of query clusters. The query clusters may be determined by applying a clustering algorithm to the user search queries included in the training data 102. For example, block 204 may include generating a respective embeddings vector representative of each search query in the training data, and applying a K-Means clustering algorithm to the set of embeddings vectors to sort the vectors (and their associated queries) into clusters. In another example, the relative distance of each embeddings vector may be determined relative to every other embeddings vector, and pairs of embeddings vectors that are closer to each other than a threshold value may be assigned to a common cluster. In these embodiments, each cluster may comprise embeddings vectors that each are within a threshold distance to every other embeddings vector in the cluster, such that the cluster includes related queries.

In those instances in which an embeddings vector is equidistant to two or more separate clusters, the embeddings vector may be assigned to one of these clusters at random, or may be assigned to the cluster to which the vector's nearest neighbor (e.g., closest other embeddings vector by distance) is assigned. In some embodiments, the embeddings vector may be assigned to the smallest of the two or more separate clusters in order to balance a distribution of vectors in clusters.

In some embodiments, a pre-determined number of clusters (e.g., five, ten, twenty etc.), may be defined at block 204. In some embodiments, the number of clusters defined at block 204 may be based on the threshold value used to define the clusters, with lower threshold values resulting in a greater number of clusters (as lower threshold values would lead to denser clusters) and with higher threshold values leading to a lower number of clusters (as higher threshold values would lead to broader clusters).

The method 200 may further include, at block 206, further training a plurality of versions (e.g., query-specific models 124) of the baseline model. In some embodiments, block 206 may include training a respective model version for each cluster defined at block 204. In particular, the initial set of results from the baseline model may be labeled based on user interaction data (e.g., user activity 112), with the user interaction data relied upon to infer result relevancy as a user interacting with a particular document after making a query would indicate that the document was responsive to the query. This labeled initial set of results may be the training dataset for the query-specific models. As such, the training data for each query-specific model may be limited to labeled initial sets of results for queries included within the cluster of queries to which the query-specific model corresponds. For example, if a given cluster of queries is defined as “high-powered water-based cleaning tools,” the training data used to train the corresponding query-specific model may be limited to initial sets of results returned by the baseline model for queries like “power washer,” “power wash cleaner,” “driveway cleaner,” etc. (which queries were clustered together at block 204) and would exclude initial sets of results returned by the baseline model for queries like “bathroom cleaner” or “water hose.”

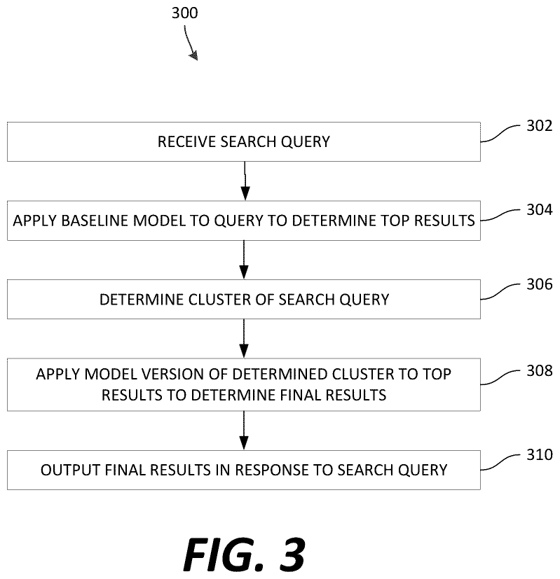

FIG. 3 is a flow chart illustrating an example method of determining, ranking, and outputting search results in response to a search query. The method 300, or one or more portions of the method 300, may be performed by the system 100, and more particularly by the search result determination and ranking system 104, in some embodiments. The method 300 may be executed after a plurality of query-specific models are trained according to the method 200, in some embodiments.

The method 300 may include, at block 302, receiving a user search query and, at block 304, applying the baseline model to the query to determine a set of top results to the received query. The baseline model may determine responsive results to the search query from the entire set of documents available to the baseline model (e.g., an entire website, where the search is entered through a website-specific search tool). In some embodiments, the baseline model 122 may preliminarily rank the responsive results based on relevance. For example, in those embodiments in which the baseline model determines responsive results by calculating a relevance score (e.g., a value indicative of how responsive-to-the-query the baseline model predicts the document to be), the preliminary ranking may be an order of the results from highest to lowest relevance score. In some embodiments, the baseline model may determine a pre-defined number of results, such that the baseline model may identify more results than are ultimately determined as responsive.

The method 300 may further include, at block 306, determining the relevant cluster to which the received search query belongs. Similar to as described above with reference to block 204, queries may be clustered by generating embeddings vectors for a set of training queries, and the vectors may then be grouped by distance. Queries corresponding to each group of vectors may be assigned to a cluster. Once each cluster is established, future queries may be assigned to (or associated with) a particular cluster by generating an embeddings vector representative of a future query and determining the group of vectors to which this generated vector belongs. The future query may then be assigned to (or associated with) the cluster of queries corresponding to the determined group.

The method 300 may further include, at block 308, applying the query-specific model associated with the cluster determined at block 306 to the set of top results determined at block 304. Accordingly, the query-specific model is applied to the initially-determined top results to re-rank those initial top results. The re-ranked results may be the final search results to the user search query.

The method 300 may further include, at block 310, outputting the final search results to the user in response to the search query (e.g., through the same interface through which the search query was received). The results may be output by causing the device to display the results, or by transmitting the search results to the device for the device to use.

Although the subsequent application of a query-specific model (e.g., model 124) may be relied upon for the ultimate (e.g., final) ranking of documents in use, the baseline model provides two distinct benefits by performing its own initial ranking. First, by providing an initial ranking, the baseline model may also provide a clear cut-off point for defining a more narrow subset for processing by the query-specific model. Second, the initial ranking may be utilized by the query-specific model as a basis for the final ranking, rather than the query-specific model having to rank from “scratch” (e.g., from an unsorted group). Given that the present disclosure is concerned with addressing the technological problems presented by maintaining a robust network of machine learning models, both of these benefits greatly improve the processing demand placed on the set of query-specific models to reduce server load and to increase the accuracy of the models.

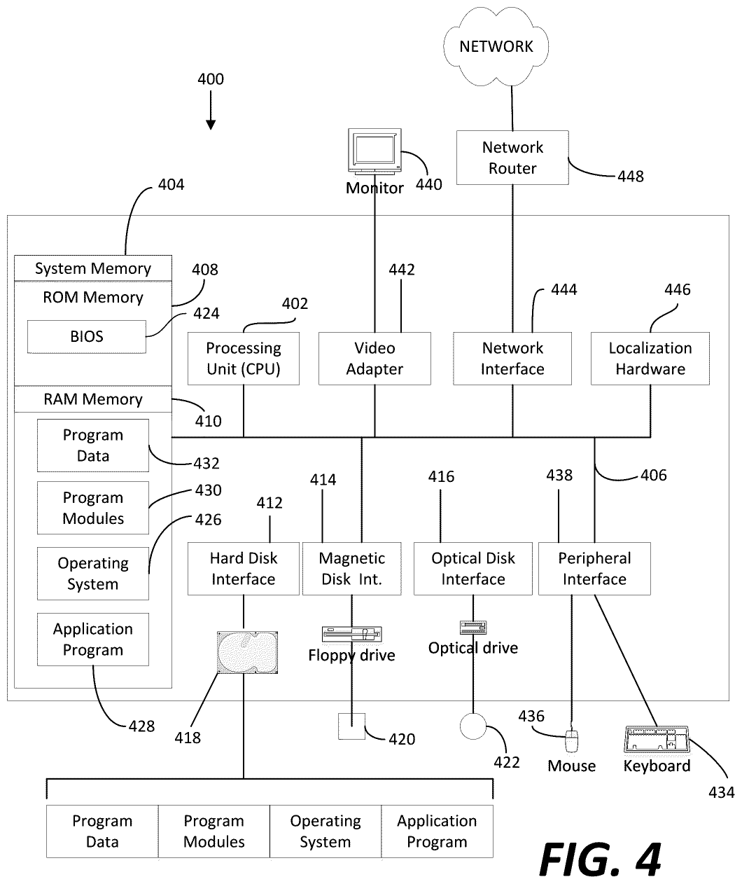

FIG. 4 is a diagrammatic view of an illustrative computing system that includes a computing system environment 400, such as a desktop computer, laptop, smartphone, tablet, or any other such device having the ability to execute instructions, such as those stored within a non-transient, computer-readable medium. Furthermore, while described and illustrated in the context of a single computing system 400, those skilled in the art will also appreciate that the various tasks described hereinafter may be practiced in a distributed environment having multiple computing systems 400 linked via a local or wide-area network in which the executable instructions may be associated with and/or executed by one or more of multiple computing systems 400. The computing system environment 400, or one or more portions of the computing system environment 400, may comprise the system 100 and/or the image processing system 104 of FIG. 1, in some embodiments.

Computing system environment 400 may include at least one processing unit 402 and at least one memory 404, which may be linked via a bus 406. Depending on the exact configuration and type of computing system environment, memory 404 may be volatile (such as RAM 410), non-volatile (such as ROM 408, flash memory, etc.) or some combination of the two. Computing system environment 400 may have additional features and/or functionality. For example, computing system environment 400 may also include additional storage (removable and/or non-removable) including, but not limited to, magnetic or optical disks, tape drives and/or flash drives. Such additional memory devices may be made accessible to the computing system environment 400 by means of, for example, a hard disk drive interface 412, a magnetic disk drive interface 414, and/or an optical disk drive interface 416. As will be understood, these devices, which would be linked to the system bus 406, respectively, allow for reading from and writing to a hard disk 418, reading from or writing to a removable magnetic disk 420, and/or for reading from or writing to a removable optical disk 422, such as a CD/DVD ROM or other optical media. The drive interfaces and their associated computer-readable media allow for the nonvolatile storage of computer readable instructions, data structures, program modules and other data for the computing system environment 400. Those skilled in the art will further appreciate that other types of computer readable media that can store data may be used for this same purpose. Examples of such media devices include, but are not limited to, magnetic cassettes, flash memory cards, digital videodisks, Bernoulli cartridges, random access memories, nano-drives, memory sticks, other read/write and/or read-only memories and/or any other method or technology for storage of information such as computer readable instructions, data structures, program modules or other data. Any such computer storage media may be part of computing system environment 400.

A number of program modules may be stored in one or more of the memory/media devices. For example, a basic input/output system (BIOS) 424, containing the basic routines that help to transfer information between elements within the computing system environment 400, such as during start-up, may be stored in ROM 408. Similarly, RAM 410, hard drive 418, and/or peripheral memory devices may be used to store computer executable instructions comprising an operating system 426, one or more applications programs 428 (such as one or more applications that execute the methods and processes of this disclosure), other program modules 430, and/or program data 432. Still further, computer-executable instructions may be downloaded to the computing environment 400 as needed, for example, via a network connection.

An end-user may enter commands and information into the computing system environment 400 through input devices such as a keyboard 434 and/or a pointing device 436. While not illustrated, other input devices may include a microphone, a joystick, a game pad, a scanner, etc. These and other input devices would typically be connected to the processing unit 402 by means of a peripheral interface 438 which, in turn, would be coupled to bus 406. Input devices may be directly or indirectly connected to processor 402 via interfaces such as, for example, a parallel port, game port, firewire, or a universal serial bus (USB). To view information from the computing system environment 400, a monitor 440 or other type of display device may also be connected to bus 406 via an interface, such as via video adapter 442. In addition to the monitor 440, the computing system environment 400 may also include other peripheral output devices, not shown, such as speakers and printers.

The computing system environment 400 may also utilize logical connections to one or more computing system environments. Communications between the computing system environment 400 and the remote computing system environment may be exchanged via a further processing device, such a network router 448, that is responsible for network routing. Communications with the network router 448 may be performed via a network interface component 444. Thus, within such a networked environment, e.g., the Internet, World Wide Web, LAN, or other like type of wired or wireless network, it will be appreciated that program modules depicted relative to the computing system environment 400, or portions thereof, may be stored in the memory storage device(s) of the computing system environment 400.

The computing system environment 400 may also include localization hardware 446 for determining a location of the computing system environment 400. In embodiments, the localization hardware 446 may include, for example only, a GPS antenna, an RFID chip or reader, a WiFi antenna, or other computing hardware that may be used to capture or transmit signals that may be used to determine the location of the computing system environment 400.

In some embodiments, a method for providing a ranked set of search results may include receiving, from a device, a query; determining, via a first machine learning model, an initial set of documents responsive to the received query; accessing a second machine learning model, the second machine learning model selected from a set of machine learning models based on a characteristic of the query; ranking, via the second machine learning model, the initial set of documents based on responsiveness to the query to generate the ranked set of search results; and outputting the ranked set of search results on the device.

In some of these embodiments, the set of machine learning models may be trained by retrieving a training dataset may include a set of queries and a set of documents, each of the set of queries associated with at least one of the set of documents; dividing the training dataset into a plurality of training subsets by grouping similar queries from the set of queries, wherein each of the plurality of training subsets includes a query group; and training each of the set of machine learning models with a single training subset of the plurality of training subsets.

In some of these embodiments, the second machine learning model may be selected from the set of machine learning models by determining the query group most similar to the received query; and selecting the second machine learning model as the one of the set of machine learning models trained based on the query group most similar to the received query.

In some of these embodiments, the dividing the training dataset may include generating, for each query of the set of queries, a respective embeddings vector representative of the query; defining a first cluster as a first embeddings vector and all other embeddings vectors within a threshold distance of the first embeddings vector; repeating the defining step until each embeddings vector may be assigned to a cluster; and defining a plurality of query groups by grouping, for each cluster, queries corresponding to the embeddings vectors in the respective cluster.

In some of these embodiments, dividing the training dataset may include generating, for each query of the set of queries, an embeddings vector representative of the query; determining a first embeddings vector having a shortest average distance to the other embeddings vectors; defining a first cluster as the first embeddings vector and all other embeddings vectors within a threshold distance of the first embeddings vector; determining a second embeddings vector having a shortest average distance to the other unclustered embeddings vectors; defining a second cluster as the second embeddings vector and all other unclustered embeddings vectors within the threshold distance of the second embeddings vector; repeating the determining and defining steps until each embeddings vector may be assigned to a cluster; and defining a plurality of query groups by grouping, for each cluster, queries corresponding to the embeddings vectors in the respective cluster.

In some of these embodiments, training each of the set of machine learning models with the single training subset of the plurality of training subsets may include training a version of the first machine learning model with the single training subset.

In some of these embodiments, determining the initial set of documents may include calculating, for each document of a set of documents, a relevance score; ordering the set of documents based on the relevance score; and determining the initial set of documents as a pre-determined number of the ordered set of documents.

In some embodiments, a system for providing a ranked set of search results may include a processor; and a memory storing instructions that, when executed, cause the processor to receive, from a device, a query; determine, via a first machine learning model, an initial set of documents responsive to the received query; access a second machine learning model, the second machine learning model selected from a set of machine learning models based on a characteristic of the query; rank, via the second machine learning model, the initial set of documents based on responsiveness to the query to generate the ranked set of search results; and output the ranked set of search results on the device.

In some of these embodiments, the set of machine learning models may be trained by retrieving a training dataset may include a set of queries and a set of documents, each of the set of queries associated with at least one of the set of documents; dividing the training dataset into a plurality of training subsets by grouping similar queries from the set of queries, wherein each of the plurality of training subsets may include a query group; and training each of the set of machine learning models with a single training subset of the plurality of training subsets.

In some of these embodiments, the second machine learning model may be selected from the set of machine learning models by determining the query group most similar to the received query; and selecting the second machine learning model as the one of the set of machine learning models trained based on the query group most similar to the received query.

In some of these embodiments, the dividing the training dataset may include generating, for each query of the set of queries, a respective embeddings vector representative of the query; defining a first cluster as a first embeddings vector and all other embeddings vectors within a threshold distance of the first embeddings vector; repeating the defining step until each embeddings vector may be assigned to a cluster; and defining a plurality of query groups by grouping, for each cluster, queries corresponding to the embeddings vectors in the respective cluster.

In some of these embodiments, dividing the training dataset may include generating, for each query of the set of queries, an embeddings vector representative of the query; determining a first embeddings vector having a shortest average distance to the other embeddings vectors; defining a first cluster as the first embeddings vector and all other embeddings vectors within a threshold distance of the first embeddings vector; determining a second embeddings vector having a shortest average distance to the other unclustered embeddings vectors; defining a second cluster as the second embeddings vector and all other unclustered embeddings vectors within the threshold distance of the second embeddings vector; repeating the determining and defining steps until each embeddings vector may be assigned to a cluster; and defining a plurality of query groups by grouping, for each cluster, queries corresponding to the embeddings vectors in the respective cluster.

In some of these embodiments, training each of the set of machine learning models with the single training subset of the plurality of training subsets may include training a version of the first machine learning model with the single training subset.

In some of these embodiments, determining the initial set of documents may include calculating, for each document of a set of documents, a relevance score; ordering the set of documents based on the relevance score; and determining the initial set of documents as a pre-determined number of the ordered set of documents.

In some embodiments, a computer-readable medium may store instructions that, when executed by a computer, cause the computer to receive, from a device, a query; determine, via a first machine learning model, an initial set of documents responsive to the received query; access a second machine learning model, the second machine learning model selected from a set of machine learning models based on a characteristic of the query; rank, via the second machine learning model, the initial set of documents based on responsiveness to the query to generate the ranked set of search results; and output the ranked set of search results on the device.

In some of these embodiments, the set of machine learning models may be trained by retrieving a training dataset may include a set of queries and a set of documents, each of the set of queries associated with at least one of the set of documents; dividing the training dataset into a plurality of training subsets by grouping similar queries from the set of queries, wherein each of the plurality of training subsets may include a query group; and training each of the set of machine learning models with a single training subset of the plurality of training subsets.

In some of these embodiments, the second machine learning model may be selected from the set of machine learning models by determining the query group most similar to the received query; and selecting the second machine learning model as the one of the set of machine learning models trained based on the query group most similar to the received query.

In some of these embodiments, dividing the training dataset may include generating, for each query of the set of queries, a respective embeddings vector representative of the query; defining a first cluster as a first embeddings vector and all other embeddings vectors within a threshold distance of the first embeddings vector; repeating the defining step until each embeddings vector may be assigned to a cluster; and defining a plurality of query groups by grouping, for each cluster, queries corresponding to the embeddings vectors in the respective cluster.

In some of these embodiments, dividing the training dataset may include generating, for each query of the set of queries, an embeddings vector representative of the query; determining a first embeddings vector having a shortest average distance to the other embeddings vectors; defining a first cluster as the first embeddings vector and all other embeddings vectors within a threshold distance of the first embeddings vector; determining a second embeddings vector having a shortest average distance to the other unclustered embeddings vectors; defining a second cluster as the second embeddings vector and all other unclustered embeddings vectors within the threshold distance of the second embeddings vector; repeating the determining and defining steps until each embeddings vector may be assigned to a cluster; and defining a plurality of query groups by grouping, for each cluster, queries corresponding to the embeddings vectors in the respective cluster.

In some of these embodiments, the initial set of documents may be determined by calculating, for each document of a set of documents, a relevance score; ordering the set of documents based on the relevance score; and determining the initial set of documents as a pre-determined number of the ordered set of documents.

While this disclosure has described certain embodiments, it will be understood that the claims are not intended to be limited to these embodiments except as explicitly recited in the claims. On the contrary, the instant disclosure is intended to cover alternatives, modifications and equivalents, which may be included within the spirit and scope of the disclosure. Furthermore, in the detailed description of the present disclosure, numerous specific details are set forth in order to provide a thorough understanding of the disclosed embodiments. However, it will be obvious to one of ordinary skill in the art that systems and methods consistent with this disclosure may be practiced without these specific details. In other instances, well known methods, procedures, components, and circuits have not been described in detail as not to unnecessarily obscure various aspects of the present disclosure.

Some portions of the detailed descriptions of this disclosure have been presented in terms of procedures, logic blocks, processing, and other symbolic representations of operations on data bits within a computer or digital system memory. These descriptions and representations are the means used by those skilled in the data processing arts to most effectively convey the substance of their work to others skilled in the art. A procedure, logic block, process, etc., is herein, and generally, conceived to be a self-consistent sequence of steps or instructions leading to a desired result. The steps are those requiring physical manipulations of physical quantities. Usually, though not necessarily, these physical manipulations take the form of electrical or magnetic data capable of being stored, transferred, combined, compared, and otherwise manipulated in a computer system or similar electronic computing device. For reasons of convenience, and with reference to common usage, such data is referred to as bits, values, elements, symbols, characters, terms, numbers, or the like, with reference to various embodiments of the present invention.

It should be borne in mind, however, that these terms are to be interpreted as referencing physical manipulations and quantities and are merely convenient labels that should be interpreted further in view of terms commonly used in the art. Unless specifically stated otherwise, as apparent from the discussion herein, it is understood that throughout discussions of the present embodiment, discussions utilizing terms such as “determining” or “outputting” or “transmitting” or “recording” or “locating” or “storing” or “displaying” or “receiving” or “recognizing” or “utilizing” or “generating” or “providing” or “accessing” or “checking” or “notifying” or “delivering” or the like, refer to the action and processes of a computer system, or similar electronic computing device, that manipulates and transforms data. The data is represented as physical (electronic) quantities within the computer system's registers and memories and is transformed into other data similarly represented as physical quantities within the computer system memories or registers, or other such information storage, transmission, or display devices as described herein or otherwise understood to one of ordinary skill in the art.

What is claimed is:

1. A method for providing a ranked set of search results, the method comprising:
receiving, from a device, a query;
determining, via a first machine learning model, an initial set of documents responsive to the received query;
accessing a second machine learning model, the second machine learning model selected from a set of machine learning models based on a characteristic of the query;
ranking, via the second machine learning model, the initial set of documents based on responsiveness to the query to generate the ranked set of search results; and
outputting the ranked set of search results on the device.

2. The method of claim 1, wherein the set of machine learning models are trained by:
retrieving a training dataset comprising a set of queries and a set of documents, each of the set of queries associated with at least one of the set of documents;
dividing the training dataset into a plurality of training subsets by grouping similar queries from the set of queries, wherein each of the plurality of training subsets comprises a query group; and
training each of the set of machine learning models with a single training subset of the plurality of training subsets.

3. The method of claim 2, wherein the second machine learning model is selected from the set of machine learning models by:
determining the query group most similar to the received query; and
selecting the second machine learning model as the one of the set of machine learning models trained based on the query group most similar to the received query.

4. The method of claim 2, wherein the dividing the training dataset comprises:
generating, for each query of the set of queries, a respective embeddings vector representative of the query;
defining a first cluster as a first embeddings vector and all other embeddings vectors within a threshold distance of the first embeddings vector;
repeating the defining step until each embeddings vector is assigned to a cluster; and
defining a plurality of query groups by grouping, for each cluster, queries corresponding to the embeddings vectors in the respective cluster.

5. The method of claim 2, wherein the dividing the training dataset comprises:
generating, for each query of the set of queries, an embeddings vector representative of the query;
determining a first embeddings vector having a shortest average distance to the other embeddings vectors;
defining a first cluster as the first embeddings vector and all other embeddings vectors within a threshold distance of the first embeddings vector;
determining a second embeddings vector having a shortest average distance to the other unclustered embeddings vectors;
defining a second cluster as the second embeddings vector and all other unclustered embeddings vectors within the threshold distance of the second embeddings vector;
repeating the determining and defining steps until each embeddings vector is assigned to a cluster; and
defining a plurality of query groups by grouping, for each cluster, queries corresponding to the embeddings vectors in the respective cluster.

6. The method of claim 2, wherein training each of the set of machine learning models with the single training subset of the plurality of training subsets comprises:
training a version of the first machine learning model with the single training subset.

7. The method of claim 1, wherein the determining the initial set of documents comprises:
calculating, for each document of a set of documents, a relevance score;
ordering the set of documents based on the relevance score; and
determining the initial set of documents as a pre-determined number of the ordered set of documents.

8. A system for providing a ranked set of search results, the system comprising:
a processor; and
a memory storing instructions that, when executed, cause the processor to:
receive, from a device, a query;
determine, via a first machine learning model, an initial set of documents responsive to the received query;
access a second machine learning model, the second machine learning model selected from a set of machine learning models based on a characteristic of the query;
rank, via the second machine learning model, the initial set of documents based on responsiveness to the query to generate the ranked set of search results; and
output the ranked set of search results on the device.

9. The system of claim 8, wherein the set of machine learning models are trained by:
retrieving a training dataset comprising a set of queries and a set of documents, each of the set of queries associated with at least one of the set of documents;
dividing the training dataset into a plurality of training subsets by grouping similar queries from the set of queries, wherein each of the plurality of training subsets comprises a query group; and
training each of the set of machine learning models with a single training subset of the plurality of training subsets.

10. The system of claim 9, wherein the second machine learning model is selected from the set of machine learning models by:
determining the query group most similar to the received query; and
selecting the second machine learning model as the one of the set of machine learning models trained based on the query group most similar to the received query.

11. The system of claim 9, wherein the dividing the training dataset comprises:
generating, for each query of the set of queries, a respective embeddings vector representative of the query;
defining a first cluster as a first embeddings vector and all other embeddings vectors within a threshold distance of the first embeddings vector;
repeating the defining step until each embeddings vector is assigned to a cluster; and
defining a plurality of query groups by grouping, for each cluster, queries corresponding to the embeddings vectors in the respective cluster.

12. The system of claim 9, wherein the dividing the training dataset comprises:
generating, for each query of the set of queries, an embeddings vector representative of the query;
determining a first embeddings vector having a shortest average distance to the other embeddings vectors;
defining a first cluster as the first embeddings vector and all other embeddings vectors within a threshold distance of the first embeddings vector;
determining a second embeddings vector having a shortest average distance to the other unclustered embeddings vectors;
defining a second cluster as the second embeddings vector and all other unclustered embeddings vectors within the threshold distance of the second embeddings vector;
repeating the determining and defining steps until each embeddings vector is assigned to a cluster; and
defining a plurality of query groups by grouping, for each cluster, queries corresponding to the embeddings vectors in the respective cluster.

13. The system of claim 9, wherein training each of the set of machine learning models with the single training subset of the plurality of training subsets comprises:
training a version of the first machine learning model with the single training subset.

14. The system of claim 8, wherein the determining the initial set of documents comprises:
calculating, for each document of a set of documents, a relevance score;
ordering the set of documents based on the relevance score; and
determining the initial set of documents as a pre-determined number of the ordered set of documents.

15. A computer-readable medium storing instructions that, when executed by a computer, cause the computer to:
receive, from a device, a query;
determine, via a first machine learning model, an initial set of documents responsive to the received query;
access a second machine learning model, the second machine learning model selected from a set of machine learning models based on a characteristic of the query;
rank, via the second machine learning model, the initial set of documents based on responsiveness to the query to generate a ranked set of search results; and
output the ranked set of search results on the device.

16. The computer-readable medium of claim 15, wherein the set of machine learning models are trained by:
retrieving a training dataset comprising a set of queries and a set of documents, each of the set of queries associated with at least one of the set of documents;
dividing the training dataset into a plurality of training subsets by grouping similar queries from the set of queries, wherein each of the plurality of training subsets comprises a query group; and
training each of the set of machine learning models with a single training subset of the plurality of training subsets.

17. The computer-readable medium of claim 16, wherein the second machine learning model is selected from the set of machine learning models by:
determining the query group most similar to the received query; and
selecting the second machine learning model as the one of the set of machine learning models trained based on the query group most similar to the received query.

18. The computer-readable medium of claim 16, wherein the dividing the training dataset comprises:
generating, for each query of the set of queries, a respective embeddings vector representative of the query;
defining a first cluster as a first embeddings vector and all other embeddings vectors within a threshold distance of the first embeddings vector;
repeating the defining step until each embeddings vector is assigned to a cluster; and
defining a plurality of query groups by grouping, for each cluster, queries corresponding to the embeddings vectors in the respective cluster.

19. The computer-readable medium of claim 16, wherein the dividing the training dataset comprises:
generating, for each query of the set of queries, an embeddings vector representative of the query;
determining a first embeddings vector having a shortest average distance to the other embeddings vectors;
defining a first cluster as the first embeddings vector and all other embeddings vectors within a threshold distance of the first embeddings vector;
determining a second embeddings vector having a shortest average distance to the other unclustered embeddings vectors;
defining a second cluster as the second embeddings vector and all other unclustered embeddings vectors within the threshold distance of the second embeddings vector;
repeating the determining and defining steps until each embeddings vector is assigned to a cluster; and
defining a plurality of query groups by grouping, for each cluster, queries corresponding to the embeddings vectors in the respective cluster.

20. The computer-readable medium of claim 15, wherein the determining the initial set of documents comprises:
calculating, for each document of a set of documents, a relevance score;
ordering the set of documents based on the relevance score; and
determining the initial set of documents as a pre-determined number of the ordered set of documents.
